(19) United States
(12) Patent Application Publication
(10) Pub. No.: US 2025/0070650 A1
(43) Pub. Date: Feb. 27, 2025

(54) POWER FACTOR CORRECTION CIRCUIT

(71) Applicant: Valeo eAutomotive Germany GmbH, Erlangen (DE)

(72) Inventors: Srikrishna CHAITANYA, Chennai (IN); Norbert MESSI, Cergy Pontoise (FR)

(73) Assignee: Valeo eAutomotive Germany GmbH, Erlangen (DE)

(21) Appl. No.: 18/812,494

(22) Filed: Aug. 22, 2024

(30) Foreign Application Priority Data
Aug. 23, 2023 (FR) 2308884

(51) Int. Cl. H02M 1/42; H02J 7/00

(52) U.S. Cl. CPC H02M 1/4208; H02J 7/007; H02J 2207/20

(57) ABSTRACT

An electric device includes input and output interfaces for connection to an AC voltage source and an electrical energy storage unit respectively. A totem-pole power factor correction circuit includes a high-frequency power switching half-bridge and a low-frequency switching half-bridge each having at least two switches, the high-frequency power switching half-bridge further including an inductance. A control system for the power factor correction circuit is designed to generate control signals for the switches of the high-frequency power switching half-bridge. The control system includes at least one positive branch designed to generate a first set of duty cycle values for the control signals from the positive half-cycle of the AC voltage at the input of the device, and a negative branch designed to generate a second set of duty cycle values for the control signals from the negative half-cycle of the AC voltage at the input of the device.

The present invention relates to an electric device comprising:
An input interface to be connected to an AC voltage source,
An output interface to be connected to an electrical energy storage unit,
A totem-pole power factor correction circuit comprising at least one high-frequency power switching half-bridge, and a low-frequency switching half-bridge, the half-bridges comprising at least two switches, the high-frequency power switching half-bridge furthermore comprising an inductance,
A control system for said power factor correction circuit, which is designed to generate the control signals for the switches of the at least one high-frequency power switching half-bridge.

Such a device is used to convert an AC voltage applied to the input interface of said device into a DC voltage by means of the power factor correction circuit, said DC voltage being intended to charge an electrical energy storage unit connected to the output interface.

During this conversion, the device may apply phase margins to the input current. This phase correction makes it possible to compensate for an angular offset between the voltage and the input current, this offset being able to generate harmonic distortions.

During this same conversion, the device may also apply gain margins to the input current.

Such a device is integrated in an on-board charger of a vehicle electrical energy storage unit, for example.

The totem-pole power factor correction circuit is a known variant of power factor correction circuits. It is an advantageous circuit due to its good efficiency and its reduced number of components in comparison with other popular solutions for power factor correction circuits.

However, it is known that, for such a device comprising a totem-pole power factor correction circuit, when the zero crossing of the AC current applied to the input interface occurs, distortions are observed in this same current.

These distortions may take the form of positive and negative current peaks around the zero crossing.

These current peaks are due to the fact that, when the AC voltage at the input of the device passes from the positive half-cycle to the negative half-cycle or vice versa, the duty cycle of the control signal for one switch of at least one high-frequency power switching half-bridge passes abruptly from a value close to 100% to a value close to 0%, and the duty cycle of the control signal for another switch of the same half-bridge passes abruptly from a value close to 0% to a value close to 100%. Following these abrupt changes in duty cycles, because of the parasitic capacitance and slow reverse recovery of the parasitic diode in the transistor switches, a voltage equal to the output voltage is applied to the inductance of the at least one high-frequency power switching half-bridge.

In the same way, it is known that, after the zero crossing of the AC voltage, the control system does not have the bandwidth to follow the abrupt changes in duty cycles and follow the profile of the input voltage to calculate the gain and phase margins to be applied to the input current. This results in a period of time in which the control signals for the at least one high-frequency power switching half-bridge are not generated appropriately by the control system, in the same way creating current peaks around the zero crossing.

Such distortions create undesirable effects in the electric device, and these effects may disrupt the proper functioning of the electrical elements connected to the interfaces, specifically an increase in the rate of harmonic distortion and common-mode disturbance.

There is a need to eliminate these distortions.

The aim of the invention is to meet this need using an electric device comprising
An input interface to be connected to an AC voltage source,
An output interface to be connected to an electrical energy storage unit,
A totem-pole power factor correction circuit comprising at least one high-frequency power switching half-bridge, and a low-frequency switching half-bridge, the half-bridges comprising at least two switches, the high-frequency power switching half-bridge furthermore comprising an inductance,
A control system for said power factor correction circuit, which is designed to generate the control signals for the switches of the at least one high-frequency power switching half-bridge,

characterized in that the control system comprises at least one positive branch designed to generate a first set of duty cycle values for the control signals from the positive half-cycle of the AC voltage at the input of the device, and a negative branch designed to generate a second set of duty cycle values for the control signals from the negative half-cycle of the AC voltage at the input of the device.

The presence of a positive branch and a negative branch within the control system makes it possible to independently generate sets of duty cycles for the control signals such that they are adapted for the positive half-cycle and for the negative half-cycle of the AC voltage at the input of the device respectively. This results in the control system more successfully managing the passage from the positive half-cycle to the negative half-cycle and the passage from the negative half-cycle to the positive half-cycle of the AC voltage applied to the input interface, and therefore a reduction in the current oscillations when the zero crossing of the AC voltage occurs, and ultimately results in a reduction in undesirable effects in the electric device.

According to one embodiment, the control system comprises a phase-locked loop module designed to generate an AC reference voltage, said AC reference voltage being in phase with the AC voltage at the input interface of the device.

In all of the above, the control system may comprise a separation module that receives the AC reference voltage at input and is designed to generate a positive voltage corresponding to the positive half-cycle of the AC reference voltage and a negative voltage corresponding to the negative half-cycle of the AC reference voltage.

In all of the above, the separation module is designed to provide a selection signal that indicates the present half-cycle, positive or negative, of the AC voltage at the input of the device.

In all of the above, the positive branch and the negative branch may each comprise a current multiplication module and a current control module, said branches being designed to receive, respectively, the positive voltage or the negative voltage of the separation module, and the current at the input of the device, and designed to each provide a set of duty cycle values to be applied to the control signals for the switches of the at least one high-frequency power switching half-bridge.

According to one embodiment, each current multiplication module is designed to receive, respectively, a voltage of the separation module and multiply it with the current at the input of the device, and to provide an instantaneous power signal at output.

According to one embodiment, each current control module is designed to receive an instantaneous power value at the output of the multiplication module, and to generate a set of duty cycle values as a function of the gain and phase margins to be applied to the AC current at the input of the power factor correction circuit.

The generation of the duty cycles may be realized, for example, by an input correspondence table or by one or more equations, taking the corresponding instantaneous power value at input.

In all of the above, the control system may comprise a duty cycle selection module designed to provide a set of duty cycle values corresponding to the set of duty cycle values of the positive branch during the positive half-cycle of the AC voltage at the input of the device, or to the set of duty cycle values of the negative branch during the negative half-cycle of the AC voltage at the input of the device.

In all of the above, the control system may comprise a pulse width modulated-signal generator designed to generate the control signals for the switches of the at least one high-frequency power switching half-bridge in accordance with the set of duty cycles at the output of the selection module.

According to one embodiment, the at least one high-frequency power switching half-bridge comprises an inductance and two transistor switches.

According to one embodiment, the transistor switches of the at least one high-frequency power switching half-bridge are composed of a transistor, for example a MOSFET transistor, and a free-wheeling diode that may be the intrinsic diode of the MOSFET transistor.

According to one embodiment, the switches of the low-frequency switching half-bridge are diodes. Two diodes are provided, for example.

As a variant, the switches of the low-frequency switching half-bridge are controllable switches, for example transistors, each switch employing an IGBT or a MOSFET, for example. In this variant, two controllable switches are provided. Still in this variant, the power factor correction circuit is bidirectional, and therefore has an operating mode in which an electrical energy storage unit connected to the output interface of the device is discharged to provide an AC voltage source in the input interface.

It will be possible to better understand the invention upon reading the following description of non-limiting exemplary embodiments thereof:

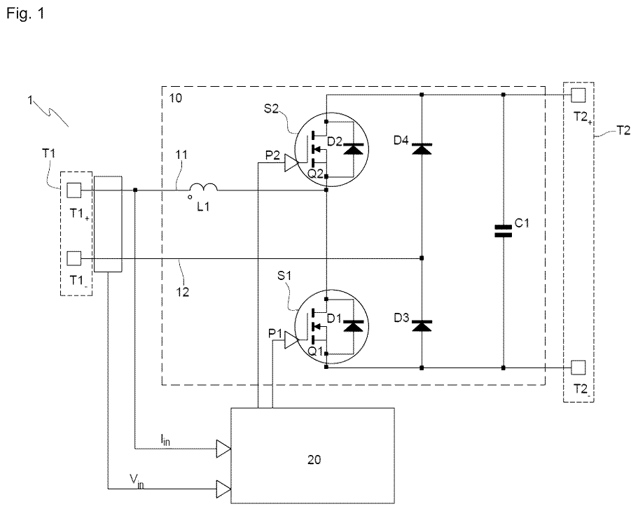

FIG. 1 shows an electric device according to an exemplary embodiment of the invention,

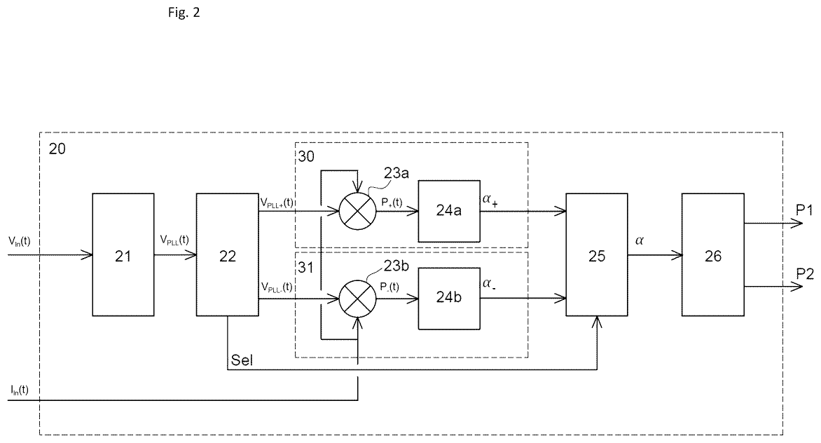

FIG. 2 shows a control system for a power factor correction circuit according to an exemplary embodiment of the invention, integrated in the electric device of FIG. 1,

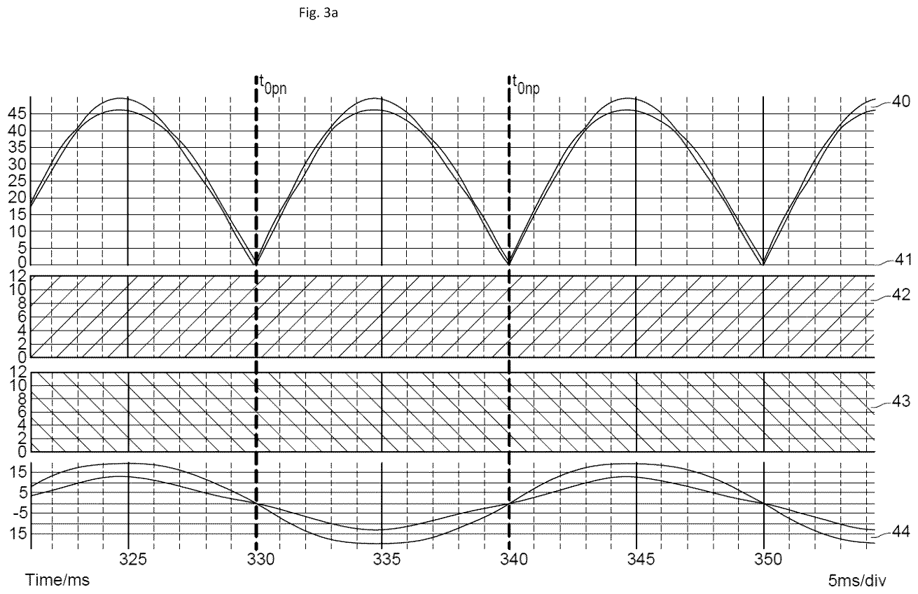

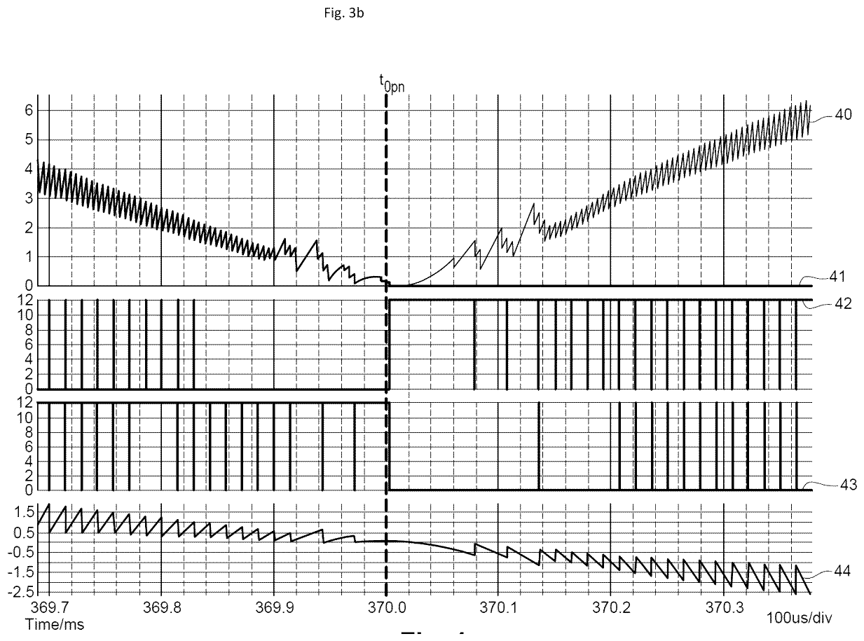

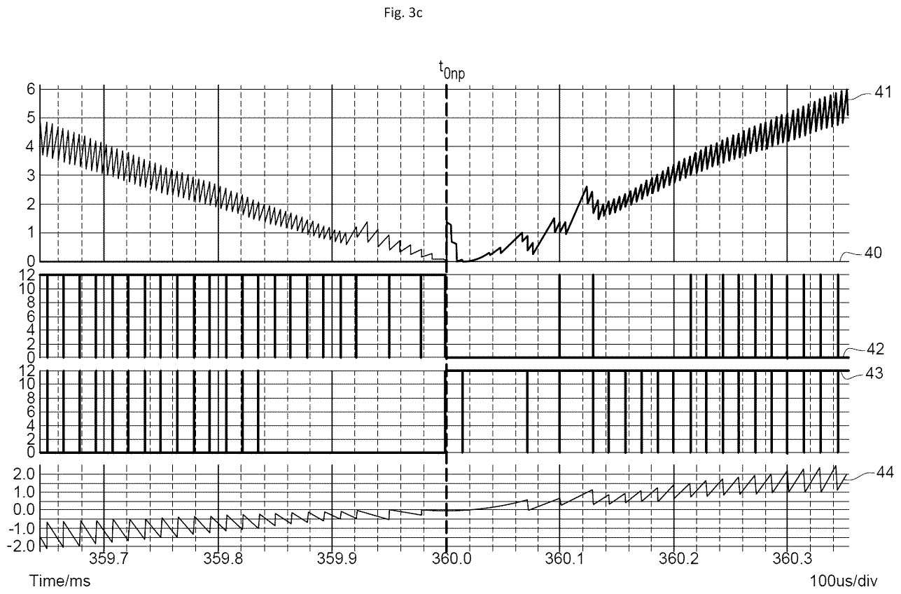

FIG. 3a, FIG. 3b and FIG. 3c correspond to voltage and current curves which make it possible to illustrate an effect of the invention.

The device 1 as shown in FIG. 1 comprises an input interface T1 and an output interface T2. The device 1 also comprises a power factor correction circuit 10, and a control system 20 for this power factor correction circuit.

According to FIG. 1, the power factor correction circuit 10 comprises a switching half-bridge 11. Said half-bridge 11 is connected to the positive terminal T1₊ of the input interface T1 by its middle branch. The half-bridge 11 comprises an inductance L1 on its middle branch. The middle branch is connected to the upper branch and the lower branch of the half-bridge 11 at a point that is common to the three branches. The lower branch comprises a lower switch S1 and the upper branch comprises an upper switch S2. The upper branch is connected to the positive terminal T2₊ of the output interface T2. The lower branch is connected to the negative terminal T2₋ of the interface T2.

The switches S1 and S2 as shown in FIG. 1 each comprise a MOSFET transistor, Q1 and Q2 respectively, and a free-wheeling diode, D1 and D2 respectively.

Said switching half-bridge 11 is referred to as a power switching half-bridge due to the presence of the inductance L1. The presence of this inductance makes it possible to apply a gain to the input current of the power factor correction circuit 10.

The switching half-bridge 11 is also referred to as a high-frequency switching half-bridge due to the fact that the switches S1 and S2 are controlled by control signals, P1 and P2 respectively, with a higher frequency than the frequency of the current applied to the input interface T1. For example, the voltage Vᵢₙ applied to the input interface T1 may be at a frequency of 50 Hz or of 60 Hz and the control signals P1 and P2 may be at a frequency between 50 KHz and 100 KHz.

The power factor correction circuit 10 shown in FIG. 1 also comprises a switching half-bridge 12. Said half-bridge 12 is connected to the negative terminal T1₋ of the input interface T1 by its middle branch. The middle branch is connected to the upper branch and to the lower branch of the half-bridge 12 at a common point. The lower branch comprises a lower diode D3 and the upper branch comprises an upper diode D4. The upper diode D4 is connected to the positive terminal T2₊ of the output interface T2 and the lower diode D3 is connected to the negative terminal T2₋ of the output interface T2.

Said switching half-bridge 12 is referred to as a low-frequency switching half-bridge due to the fact that the diodes D3 and D4 pass from blocking to conducting and vice versa depending on the frequency of the current applied to the input interface T1.

The power factor correction circuit 10 also comprises a filtering capacitance C1 connected between the positive terminal T2+ and the negative terminal T2− of the output interface T2.

Such a power factor correction circuit 10 as shown in FIG. 1, with a high-frequency power switching half-bridge 11 and a low-frequency switching half-bridge 12, is referred to as a totem-pole power factor correction circuit.

The device 1 shown in FIG. 1 also comprises a power factor correction circuit control system 20 designed to generate the control signals P1 and P2 for the switches S1 and S2 of the high-frequency power switching half-bridge 11 of the power factor correction circuit 10. Said control system 20 receives, at input, the AC voltage Vᵢₙ(t) and the AC current Iᵢₙ(t) which are applied at the input of the device 1.

The power factor correction circuit control system 20 may be a computer, for example a micro-controller, or an integrated circuit, for example an FPGA or an ASIC.

The power factor correction circuit control system 20 will be described with reference to FIG. 2.

The control system 20 as described in FIG. 2 comprises a phase-locked loop module 21. This module is designed to generate, from the voltage Vᵢₙ drawn at the input of the device 1, an AC reference voltage V_{PLL}(t). This reference voltage V_{PLL}(t) is designed to be in phase with the input voltage Vᵢₙ(t).

Said AC reference voltage V_{PLL}(t) is supplied to a separation module 22, said module being designed to generate a positive voltage V_{PLL+}(t) corresponding to the positive half-cycle of the reference AC voltage V_{PLL}(t) and a negative voltage V_{PLL-}(t) corresponding to the negative half-cycle of V_{PLL}(t).

The separation module 22 is furthermore designed to generate a selection signal Sel that indicates the present half-cycle of the reference voltage V_{PLL}(t).

The control system 20 as described in FIG. 2 comprises a positive branch 30 and a negative branch 31.

The positive branch 30 is designed to receive the positive reference voltage V_{PLL+}(t) of the separation module 22 and the current Iᵢₙ (t) at the input of the device 1, and is designed to generate a signal α₊. The signal α₊ corresponds to the duty cycle values to be applied to the control signals P1 and P2, respectively, for the switches S1 and S2 of the high-frequency power switching half-bridge 11, to apply the desired phase and gain margins to the input current Iᵢₙ (t).

The negative branch 31 is designed to receive the negative reference voltage V_{PLL-}(t) of the separation module 22 and the current Iᵢₙ (t) at the input of the device 1, and is designed to provide a signal α₋. The signal α₋ corresponds to the duty cycle values to be applied to the control signals P1 and P2, respectively, for the switches S1 and S2 of the high-frequency power switching half-bridge 11, to apply the desired phase and gain margins to the input current Iᵢₙ (t).

As an example, the values of the desired phase and gain margins may be 45° and 12 dB respectively.

The positive branch 30 as shown in FIG. 2 comprises a multiplication module 23a designed to multiply the positive reference voltage V_{PLL+}(t) at the output of the separation module 22 and the current Iᵢₙ (t) drawn at the input of the device 1. The multiplication operation results in the obtaining of an instantaneous power value P₊(t) representative of the instantaneous power at the input of the device 1 during the positive half-cycle of V_{PLL}(t).

The positive branch 30 furthermore comprises a current control module 24a. This module is designed to generate a set of duty cycle values α₊ of the control signals P1 and P2 for the switches S1 and S2 of the high-frequency power switching half-bridge 11. This set of duty cycle values α₊ is generated from the instantaneous power P₊(t) at the output of the multiplication module 23a.

Similarly in the example shown in FIG. 2, the negative branch 31 comprises a multiplication module 23b taking, at input, the negative reference voltage V_{PLL-}(t) and the input current Iᵢₙ (t), and generating the instantaneous power P. (t) representative of the instantaneous power at the input of the device 1 during the negative half-cycle of V_{PLL}(t). This instantaneous power P₋(t) is transmitted to a current control module 24b designed to generate a set of duty cycle values α₋ of the control signals P1 and P2 for the switches S1 and S2 of the high-frequency power switching half-bridge 11.

In the example shown in FIG. 2, the set of duty cycle values α₊ at the output of the positive branch 30 and the set of duty cycle values α₋ at the output of the negative branch 31 are provided to a selection module 25. By virtue of the selection signal Sel at the output of the separation module 22, this selection module 25 determines which set of values, either α₊ for the positive half-cycle or α₋ for the negative half-cycle, must be used to control the switches S1 and S2 of the high-frequency power switching half-bridge 11. The set of duty cycle values selected at the output of the selection module 25 is denoted α.

The control system shown in FIG. 2 also comprises a pulse width modulated-signal generator 26. The signals P1 and P2 generated by this generator 26 are the control signals for the switches S1 and S2 of the high-frequency power switching half-bridge 11. The control signals P1 and P2 are generated by the generator 26 with a duty cycle in accordance with the set of duty cycle values a provided by the selection module 25.

FIG. 3a shows, on one and the same time scale on the X axis:
A graph 40 showing the current, in amperes, flowing through the diode D3,
A graph 41 showing the current, in amperes, flowing through the diode D4,
A graph 42 showing the voltage, in volts, of the control signal P2,
A graph 43 showing the voltage, in volts, of the control signal P1, and
A graph 44 showing the input current Iᵢₙ (t) in amperes.

FIG. 3b shows, on one and the same time scale on the X axis, the same graphs as FIG. 3a, focused on a passage of Iᵢₙ from the positive half-cycle to the negative half-cycle at the instant t₀ₚₙ.

FIG. 3c shows, on one and the same time scale on the X axis, the same graphs as FIG. 3a, focused on a passage of Iᵢₙ from the negative half-cycle to the positive half-cycle at the instant t₀ₙₚ.

In this example, the input current Iᵢₙ (t) has a frequency of 50 Hz, which may be observed on graphs 40, 41 and 44 of FIG. 3a.

In this example, the frequency of the control signals P1 and P2 is 80 KHz, which may be observed on graphs 42 and 43 of FIGS. 3b and 3c.

It may be observed in graphs 40 and 41 of FIGS. 3a, 3b and 3c that the diodes D3 and D4 are conducting in each case during the negative half-cycle and the positive half-cycle of the input current Iᵢₙ.

It may be observed in FIGS. 3a, 3b and 3c that on graph 44 the input current Iᵢₙ (t) does not comprise any notable distortions when the zero crossing occurs, be this during the passage from the positive half-cycle to the negative half-cycle as shown in FIG. 3b, or be this during the passage from the negative half-cycle to the positive half-cycle as shown in FIG. 3c.

In the example shown in FIG. 3b, before the current Iᵢₙ (t) passes from the positive half-cycle to the negative half-cycle at the instant t₀ₚₙ, it may be seen on graph 42 that the control signal P2 has a duty cycle of 0%, and on graph 43 that the control signal P1 has a duty cycle close to 100%. This zero duty cycle of the control signal P2 allows the parasitic capacitance of the switch S2 to discharge completely before the zero crossing and makes it possible to avoid a current peak.

In the example shown in FIG. 3c, before the current Iᵢₙ (t) passes from the negative half-cycle to the positive half-cycle at the instant t₀ₙₚ, it may be seen on graph 42 that the control signal P2 has a duty cycle close to 100%, and on graph 43 that the control signal P1 has a zero duty cycle. This zero duty cycle of the control signal P1 allows the parasitic capacitance of the switch S1 to discharge completely before the zero crossing and makes it possible to avoid a current peak.

In the example shown in FIG. 3b, after the current Iᵢₙ(t) passes from the positive half-cycle to the negative half-cycle at the instant t₀ₚₙ, it may be seen on graph 42 that the control signal P2 has a duty cycle close to 100%, and on graph 43 that the control signal P1 has a zero duty cycle. This zero duty cycle of the control signal P1 makes it possible to wait for the diode D3 to begin conducting, as may be seen on graph 40, before closing the switch S1 and conducting the current. A current peak is thus prevented after the zero crossing of the current Iᵢₙ(t).

In the example shown in FIG. 3c, after the current Iᵢₙ (t) passes from the negative half-cycle to the positive half-cycle at the instant t₀ₙₚ, it may be seen on graph 42 that the control signal P2 has a zero duty cycle and on graph 43 that the control signal P1 has a duty cycle close to 100%. This zero duty cycle of the control signal P2 makes it possible to wait for the diode D4 to begin conducting, as may be seen on graph 41, before closing the switch S2 and conducting the current. A current peak is thus prevented after the zero crossing of the current Iᵢₙ (t).

These duty cycle values of the control signals P1 and P2, which make it possible to prevent current peaks before and after the zero crossings of the input current Iᵢₙ (t), are generated due to the separation of the control system into two branches, positive 30 and negative 31. The positive branch 30 and the negative branch 31 see only positive or zero voltages and negative or zero voltages, respectively, and the change of half-cycle of the input voltage Vᵢₙ is not managed by the current control modules 24a and 24b generating the duty cycle of the control signals, resulting in better management of the zero crossing of the input voltage Vᵢₙ and a reduction in the distortions of the AC current Iᵢₙ (t).

The invention is not limited to the exemplary embodiment that has just been described.

In particular, the power factor correction circuit 10 may comprise more than one high-frequency power switching half-bridge. In this case, the number of control signals generated by the control system 20 is increased in accordance with the number of switches in the high-frequency power switching half-bridges.

In particular, the low-frequency switching half-bridge 12 may comprise controllable switches, for example transistor switches, rather than diodes. In this case, these controllable switches may be controlled by control signals which have a frequency that is ideally equal to the frequency of the AC voltage at the input of the device. These controllable switches may be IGBT transistors or MOSFET transistors, for example.

In this case, the power factor correction circuit 10 may be a bidirectional circuit, and thus have an operating mode in which an AC voltage source is present on the interface T2 to supply an AC voltage to the interface T1. For example, an electrical energy storage unit connected to the interface T2 is discharged to supply an AC voltage to the input interface T1.

1. Electric device comprising
an input interface to be connected to an AC voltage source,
an output interface to be connected to an electrical energy storage unit,
a totem-pole power factor correction circuit comprising at least one high-frequency power switching half-bridge, and a low-frequency switching half-bridge, the half-bridges each comprising at least two switches, the high-frequency power switching half-bridge furthermore comprising an inductance,
a control system for said power factor correction circuit, which is designed to generate the control signals for the switches of the at least one high-frequency power switching half-bridge,
wherein the control system comprises at least one positive branch designed to generate a first set of duty cycle values for the control signals from the positive half-cycle of the AC voltage at the input of the device, and a negative branch designed to generate a second set of duty cycle values for the control signals from the negative half-cycle of the AC voltage at the input of the device.

2. Electric device according to claim 1, wherein the control system comprises a phase-locked loop module designed to generate an AC reference voltage, said AC reference voltage being in phase with the AC voltage at the input of the device.

3. Electric device according to claim 2, wherein the control system comprises a separation module that receives the AC reference voltage at input and is designed to generate a positive voltage corresponding to the positive half-cycle of the AC reference voltage and a negative voltage corresponding to the negative half-cycle of the AC reference voltage.

4. Electric device according to claim 3, wherein the separation module is designed to provide a selection signal (Sel) that indicates the present half-cycle, positive or negative, of the AC voltage at the input of the device.

5. Device according to claim 3, wherein the positive branch and the negative branch each comprise a current multiplication module and a current control module, said branches being designed to receive, respectively, the positive voltage or the negative voltage of the separation module and the current at the input of the device, and designed to each provide a set of duty cycle values to be applied to the control signals for the switches of the at least one high-frequency power switching half-bridge.

6. Device according to claim 5, wherein each current multiplication module is designed to receive a voltage of the separation module and multiply it with the input current of the device, and designed to provide an instantaneous power signal at output.

7. Device according to claim 6, wherein each current control module is designed to receive the instantaneous power value at the output of a multiplication module, and to generate a set of duty cycles as a function of the gain and phase margins to be applied to an AC current at the input of the power factor correction circuit.

8. Electric device according to claim 5, wherein the control system comprises a duty cycle selection module designed to provide a set of duty cycles corresponding to the set of duty cycles of the positive branch during the positive half-cycle of the AC voltage at the input of the device, or to the set of duty cycles of the negative branch during the negative half-cycle of the AC voltage at the input of the device.

9. Electric device according to claim 1, wherein the control system comprises a pulse width modulated-signal generator designed to generate the control signals for the switches of the at least one high-frequency power switching half-bridge in accordance with the set of duty cycles at the output of the selection module.

10. On-board charger of an electrical energy storage unit comprising an electric device according to claim 1.

11. Device according to claim 4, wherein the positive branch and the negative branch each comprise a current multiplication module and a current control module, said branches being designed to receive, respectively, the positive voltage or the negative voltage of the separation module and the current at the input of the device, and designed to each provide a set of duty cycle values to be applied to the control signals for the switches of the at least one high-frequency power switching half-bridge.

12. Electric device according to claim 6, wherein the control system comprises a duty cycle selection module designed to provide a set of duty cycles corresponding to the set of duty cycles of the positive branch during the positive half-cycle of the AC voltage at the input of the device, or to the set of duty cycles of the negative branch during the negative half-cycle of the AC voltage at the input of the device.

13. Electric device according to claim 2, wherein the control system comprises a pulse width modulated-signal generator designed to generate the control signals for the switches of the at least one high-frequency power switching half-bridge in accordance with the set of duty cycles at the output of the selection module.

14. On-board charger of an electrical energy storage unit comprising an electric device according to claim 2.

15. Electric device according to claim 7, wherein the control system comprises a duty cycle selection module designed to provide a set of duty cycles corresponding to the set of duty cycles of the positive branch during the positive half-cycle of the AC voltage at the input of the device, or to the set of duty cycles of the negative branch during the negative half-cycle of the AC voltage at the input of the device.

16. Electric device according to claim 3, wherein the control system comprises a pulse width modulated-signal generator designed to generate the control signals for the switches of the at least one high-frequency power switching half-bridge in accordance with the set of duty cycles at the output of the selection module.

17. On-board charger of an electrical energy storage unit comprising an electric device according to claim 3.

18. Electric device according to claim 4, wherein the control system comprises a pulse width modulated-signal generator designed to generate the control signals for the switches of the at least one high-frequency power switching half-bridge in accordance with the set of duty cycles at the output of the selection module.

19. On-board charger of an electrical energy storage unit comprising an electric device according to claim 4.

20. Electric device according to claim 5, wherein the control system comprises a pulse width modulated-signal generator designed to generate the control signals for the switches of the at least one high-frequency power switching half-bridge in accordance with the set of duty cycles at the output of the selection module.
